(19) United States
(12) Patent Application Publication
(10) Pub. No.: US 2008/0004039 A1
(43) Pub. Date: Jan. 3, 2008

(54) Portable computer system having wireless communication functionality and global geographic positioning functionality

(75) Inventors: Robert Ober, San Jose, CA (US); William T. Edwards, Austin, TX (US); R. Stephen Polzin, San Jose, CA (US)

Correspondence Address: MEYERTONS, HOOD, KIVLIN, KOWERT & GOETZEL (AMD), P.O. BOX 398, AUSTIN, TX, 78767-0398, US

(73) Assignee: Advanced Micro Devices, Inc.

(21) Appl. No.: 11/478,737

(22) Filed: Jun. 30, 2006

(51) Int. Cl. H04Q 7/20

(52) U.S. Cl. 455/456.1; 455/12.1

(57) ABSTRACT

A portable computer system including wireless communication functionality and global geographic positioning functionality includes a processor coupled to a wireless module, and a global positioning unit coupled to the wireless module and the processor. The wireless module may communicate with a wireless network via a wireless connection. The global positioning unit may be configured to receive geographic location information and to determine a current geographic location of the portable computer system based upon the received geographic location information. The processor may execute system software that may be configured to reconfigure system configuration settings such as security and authentication settings, and system clock settings, for example, dependent upon changes in the current geographic location information. In addition, an authenticated administrative level user may send one or more commands to the wireless module. The commands may cause a system storage to be made unreadable.

### BACKGROUND OF THE INVENTION

1. Field of the Invention

This invention relates to portable computer systems and, more particularly, to portable computer systems that include wireless communication functionality and global geographic positioning functionality.

2. Description of the Related Art

As the computing power and speed of the microprocessors that drive computing platforms has increased, so has the demand for computer system portability. Most, if not all, of the features and applications available to desktop computers are now available on portable computers. As such, these portable computing platforms may be used in a changing geographic environment. For example, during a long flight, a user may cross multiple time zones. Similarly, a user may shutdown the system in one location and boot up in another. Thus, it may be desirable for the portable computing platform to recognize the change in location.

In addition, since portable computers may be easily misplaced, lost, or stolen any sensitive data stored within them may be vulnerable. Conventional machines sometimes rely on a password-protected login. Although useful to protect against some unauthorized users from using the machine, this type of protection may not be enough to protect data stored on the hard disk or other system storage. Accordingly, it may be desirable to implement some form of additional security for portable computer systems that become misplaced and/or stolen.

### SUMMARY

Various embodiments of a portable computer system including wireless communication functionality and global geographic positioning functionality are disclosed. In one embodiment, the portable computer system includes a processor coupled to a wireless module, and a global positioning unit coupled to the wireless module and the processor. The wireless module may communicate with a wireless network via a wireless connection. The global positioning unit may be configured to receive geographic location information and to determine a current geographic location of the portable computer system based upon the received geographic location information.

In one specific implementation, the processor may execute system software that may be configured to reconfigure system configuration settings such as security and authentication settings, and system clock settings, for example, dependent upon changes in the current geographic location information.

In various other implementations, the portable computer system includes an authentication unit that may be configured to generate and provide authentication information to the wireless module. The wireless module may be further configured to provide the authentication information, without intervention by the processor, to a computer network in response to a challenge from the computer network during initiation of a connection to the computer network. In addition, the wireless module may be configured to receive and authenticate an incoming communication from an administrative level user without intervention by the processor. Further, the portable computer system includes a storage device coupled to the processor and may be configured to store system and user information. The wireless module may also be configured to cause the information within the storage to be unreadable in response to receiving one or more commands received from the administrative level user.

### BRIEF DESCRIPTION OF THE DRAWINGS

FIG. 1 is a block diagram of one embodiment of a portable computer system.

FIG. 2 is a diagram depicting an embodiment of the portable computer system of FIG. 1 being used in a wireless network and receiving geographic location information.

FIG. 3 is a flow diagram describing the operation of one embodiment of the portable computer system of FIG. 1.

FIG. 4A is a perspective view drawing of one embodiment of the portable computer system of FIG. 1.

FIG. 4B is a perspective view drawing of another embodiment of the portable computer system of FIG. 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

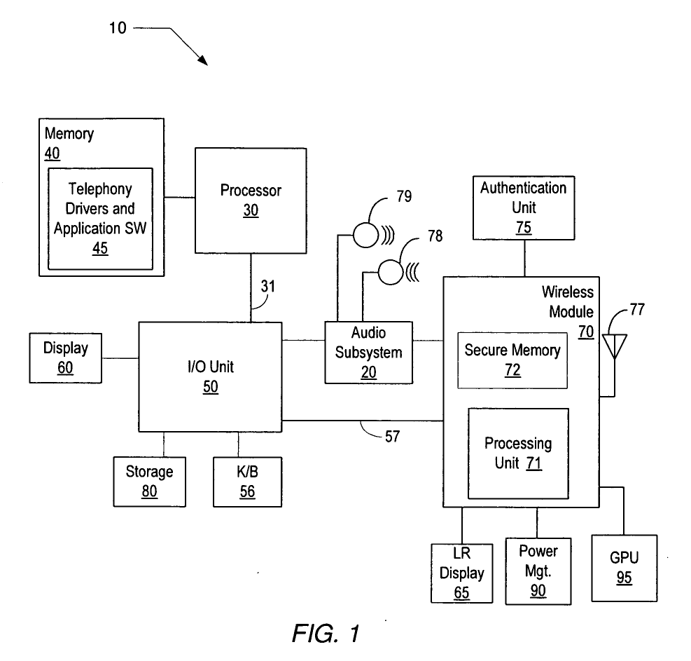

Turning now to FIG. 1, a block diagram of one embodiment of a portable computer system including wireless functionality is shown. Portable computer system 10 includes a processor 30 coupled to a memory 40 and to an input/output (I/O) unit 50. I/O hub 50 is coupled to various I/O devices such as a display 60, a storage device 80, a keyboard 56, and a wireless module 70. Wireless module 70 is coupled to a global positioning unit (GPU) 95, a low-resolution display 65, a power management unit 90, and an authentication unit 75. In addition, an audio subsystem 20 is coupled between I/O unit 50 and wireless module 70. In one implementation, portable communication device 10 may be a laptop, notebook, or other portable computer system.

It is noted that portable computer system 10 may include various other components and circuits that have been omitted for simplicity. It is further noted that the components of the computing subsystem are depicted in FIG. 1 for illustrative purposes. It is contemplated that the functionality associated with the various components may be distributed differently such that the lines between blocks may be drawn differently. Moreover, it is entirely possible that the functionality shown in FIG. 1 may be implemented on a single integrated circuit chip, such a system on a chip (SOC) implementation, as desired.

In the illustrated embodiment, processor 30 may be illustrative of a microprocessor that implements the x86 architecture. Although in other embodiments, processor 30 may be any type of processor implemented with any type of architecture. In 25 one embodiment, processor 30 may include a memory controller (not shown) to facilitate memory transactions directed to memory 40, for example. In addition, processor 30 may include various interface circuits such as a host interface (not shown) for controlling transactions with I/O unit 50.

I/O unit 50 may be any of a variety of I/O controllers that may include bridging and graphics circuits (not shown) that may be used as interfaces between processor 30 and the various I/O devices and buses to which it is coupled. For example, in one embodiment, I/O unit 50 may be coupled to processor 30 via a HyperTransport™ link 31. In such an embodiment, I/O unit 50 may include one or more HyperTransport™ to peripheral component interconnect (PCI) and/or a HyperTransport™ to universal serial bus (USB) bridges for connection to PCI and USB devices, respectively, for example. In addition, in one embodiment, I/O unit 50 may be coupled to wireless module 70 via a USB, HyperTransport™ or other type of link 57, although other interconnects are contemplated. Further, I/O unit 50 may include and graphics functionality for generation of the various signals used in association with display 60 and LR display 65, for example.

It is noted that although I/O unit 50 is coupled to processor 30 via a link such as a HyperTransport™ link, for example, it is contemplated that in other embodiments, processor 30 may be coupled to the components of the system using a more traditional system architecture. For example, processor 30 may be coupled to a bus bridge (not shown) such as a Northbridge via shared bus arrangement (e.g., front side bus (FSB)). In addition, a separate bus bridge such as a Southbridge (not shown) may be coupled to the Northbridge for coupling to various other peripheral devices (e.g., storage 80, KB 56, etc.). In such embodiments, wireless module 70 may be coupled to the Northbridge via any type of link such as a USB link, for example.

The audio subsystem 20 may include audio functionality including analog-to-digital and digital to-analog circuits for generation of the various signals associated with microphone 79 and speaker 78, for example.

Storage 80 may be a mass storage device. For example, in one embodiment storage 80 may include one or more hard disk drives. In other embodiments, storage 80 may include other types of storage media such as a non-volatile random access memory (RAM) device (e.g., a memory stick, or flash drive), compact disk (CD) drive, digital video disk (DVD) drive, tape drive, floppy drive, and the like.

In one embodiment, display 60 may be a liquid crystal display (LCD) or other type of displays such as may be common to portable laptop and notebook computers. In contrast, LR display 65 may be a display such as the type of display used on a mobile telephone or a personal digital assistant (PDA) for example. In one embodiment, LR display 65 may have a lower resolution than display 60. As will be described in greater detail below, in some modes of operation of portable communication device 10, LR display 65 may be used exclusively, while in other modes, display 60 may be used exclusively, and in still other modes, both displays may used concurrently.

As shown, wireless module 70 is coupled to an antenna 77. Wireless module 70 includes a processing unit 71 and a secure memory 72. Wireless module 70 may include the functionality of a wireless communication device such as a mobile telephone, wireless modem, or other wireless network connection device, for example. As such, in one embodiment, processing unit 71 may execute instructions and perform functions, and may include analog, digital, radio frequency (RF) and baseband circuits (not shown) that may function to perform such tasks as RF signal reception and transmission, up-conversion and down-conversion of the RF signals, analog-to-digital conversion, digital-to-analog conversion, digital signal processing of the baseband signals, as well as monitoring and control functions. Accordingly, in various implementations, processing unit 71 may include hardware that includes a separate processor such as an advanced RISC machine (ARM) processor, for example, a digital signal processing unit, and/or one or more hardware accelerators for handling complex algorithms such as encryption and decryption.

As mentioned above, wireless module 70 may communicate with a wireless network such as a wireless wide area network that may include a wireless telephone network, for example. The wireless network may conform to any of a variety of communication standards that may be compatible with various technologies such as the second (2G), third (3G) and fourth (4G) generation mobile phone technologies. In addition, the wireless network may be a wireless wide area network implemented to be compatible with such protocols as WiMax, WiBro, NextNet, and others. More particularly, in various embodiments, wireless module 70 may employ a time-division multiple access (TDMA), a code division multiple access (CDMA) and/or a wideband CDMA (WCDMA) technique to implement standards such as the Global System for Mobile Communications (GSM) standard, the Personal Communications Service (PCS) standard, and the Digital Cellular System (DCS) standard, for example. In addition, many data transfer standards that work cooperatively with the various technology platforms may also be supported. For example, wireless module 70 may also implement the General Packet Radio Service (GPRS) standard, the Enhanced Data for GSM Evolution (EDGE) standard, which may include Enhanced General Packet Radio Service standard (E-GPRS) and Enhanced Circuit Switched Data (ESCD), and the high speed circuit switched data (HSCSD) standard, high speed downlink packet access (HSDPA), high speed uplink packet access (HSUPA), evolution data optimized (EV-DO), among others.

In one embodiment, memory 40 may be a system memory that is used to store instructions and data that may be used by processor 30 as well as other devices (e.g., I/O unit 50). In various embodiments, memory 40 may be implemented using any of a variety of volatile or non-volatile memory devices. For example, memory 40 may be implemented using any number of memory devices in the dynamic RAM family of devices. In one embodiment, memory 40 may be implemented using removable or non-removable memory modules with the memory devices affixed thereto. However, other memory device configurations are possible and contemplated.

As shown, memory 40 includes telephony drivers and application software 45 stored therein. It is noted that telephony drivers and application software 45 may be stored more permanently within storage 80 and during run time, at least portions of the instructions and data being executed by processor 30 may be loaded into memory 40.

Portable computer system 10 may be described in terms of including a computing subsystem and a wireless subsystem. In one embodiment, the computing subsystem may include the components that typically make up a computing platform. For example, the computing subsystem may include processor 30, memory 40, I/O unit 50, display 60 and so on. The wireless subsystem may include wireless module 70, which includes processing unit 71, memory 72, and LR display 65. As will be described in greater detail below, in one embodiment, portable computer system 10 may operate in various modes.

During operation of portable computer system 10, either subsystem may be used alone, or both subsystems may be used together in various combinations. For example, in one mode, portable computer system 10 may operate such that only the wireless module 70 may be in operation while the computing subsystem components may be in a standby or low power state. As such, portable computer system 10 may be operated as a wireless communication device such as a mobile telephone or a personal digital assistant (PDA). In such an embodiment, LR display 65 may be used. In another mode, the wireless subsystem may be turned off or placed in a standby mode and portable computer system 10 may operate simply as a laptop or notebook computer. In still other modes, portable computer system 10 may operate using various combinations of computing and wireless communication functionality. It is noted that while portable computer system 10 is operated in the different modes, one or more components may be powered down or placed in a standby mode or other low power states. As such, portable computer system 10 includes a power management unit 90 that may manage the different modes and power states and any switching therebetween.

Depending upon the application software and drivers that may be installed, portable computer system 10 may function as a laptop computer with a fully integrated wireless communication platform that includes voice and data transfer functionality. In addition, due to the integration of the wireless hardware and the telephony drivers and application software 45 on the portable computing platform, the management of various email, address books, and other files may be seamless to a user. For example, the telephony drivers and application software 45 may include instructions that may be used to configure the wireless module 70. In one implementation, a user may select a driver via the operating system or other mechanism, for example. The driver may configure one or more operational characteristics and/or behaviors of wireless module 70. In addition, the telephony drivers and application software 45 may be used to manage email, address books, phone lists, databases, calendars, and other information traditionally used on a mobile telephone. The application software may also include applications that may be run by processor 30 such as spreadsheet, word processing, games, and the like. Once the user configures the system operation, such operations as managing general IP data traffic, receiving incoming calls, sending outgoing calls, receiving and sending email, and display management may be fully automated from a platform user perspective.

In one embodiment, GPU 95 may be configured to provide geographic coordinate information corresponding to a current geographic location of portable computer system 10 to processing unit 71 and/or to processor 30. For example, in one embodiment, GPU 95 may be configured to receive global positioning system (GPS) coordinate information that may be used to determine longitude, latitude, elevation, and time of day. In some embodiments, the coordinate information may be sent via a GPS satellite network or via a GPS terrestrial network, or a combination. In other embodiments, other types of systems and networks may provide the coordinate information. For example, within some corporate facilities, location beacons or other terrestrial beacons may transmit coordinate information that may be received by GPU 95. Further GPU 95 may receive information from wireless module 70 that corresponds to the wireless network. For example, during wireless communication with the network, information corresponding to the particular cells or base stations may be received by wireless module 70 and provided to GPU 95. GPU 95 may be configured to determine a relative location based on the network location information. In some embodiments, this network based geographic location information may be used by GPU 95 in lieu of, or in combination with the satellite and other terrestrial based geographic location information to determine a current geographic location of portable computer system 10.

In one embodiment, the geographic location information may be used by software executing on wireless module 70 and/or processor 30. More particularly, in one embodiment, portable computer system 10 may be securely accessed by a remote user having administrative privileges. The remote user may perform various administrative tasks including such tasks as querying the portable computer system 10, determining a current location the portable computer system 10, disabling portable computer system 10, and erasing, wiping, or patterning the mass storage 80 and memory 40 of any data, for example. In various embodiments, these administrative tasks may be performed even if portable computer system 10 is in a low power state or powered off, due to wake up functionality of portable computer system 10. Accordingly, in the event portable computer system 10 is lost or believed to be stolen, it may be possible to determine the current location and/or the operational status of portable computer system 10 by sending appropriate commands to wireless module 70.

In addition, in other embodiments, software executing on wireless module 70 and/or processor 30 may use the geographic location information to make decisions locally (e.g., without remote administrative user access) dependent on the location of portable computer system 10. For example, wireless module 70 may be configured to determine its current location, and to increase and/or decrease security and authentication functions, to erase, wipe, or pattern the mass storage 80 and memory 40 of any data, and to disable portable computer system 10 if the current location is not within a given radius of a target location. It is noted that these tasks may be performed with and without user intervention. For example, in some embodiments, software and hardware may be configured to autonomously perform tasks based upon the geographic location information.

In addition to security related operations, wireless module 70 and or processor 30 may execute instructions that may use the geographic location information to make other location-based decisions. For example, the geographic location information may be used for selecting/modifying wireless connection protocol and/or service provider, adjusting time zone and geographic mapping information, synchronizing the system clock to a reference clock, generating alerts that correspond to specific locations for the user, and the like. It is noted that, as above these tasks may be performed with and without user intervention. For example, in some embodiments, software and hardware may be configured to autonomously perform tasks based upon the geographic location information. In other embodiments, a user may be prompted to authorize certain tasks.

In one embodiment, authentication unit 75 may be used to store a unique number. In one embodiment, the unique number may be the private key of an asymmetric cryptography key pair. The private key may be generated from a unique personal identification number, or the telephone number of the unit, for example.

In one embodiment authentication unit 75 may be a device such as a smart card implemented as a subscriber identity module (SIM) card, for example. As such, authentication unit 75 may also include processing functionality configured to generate cryptographic key/signature information. For example, in addition to the unique personal identification number described above, a unique cryptographic key may be used as a seed value to generate other keys and signatures. The signatures may be used during authentication sequences between the wireless module 70 and the wireless network. In one implementation, authentication unit 75 may provide the unique key to wireless module 70, which may be used to uniquely identify to the network the identity of the portable computer system 10. As such, processing unit 71 may be configured to generate key and signature information.

In another implementation, since authentication unit 75 may include processing functionality to generate cryptographic key information, the wireless network may present a challenge to wireless module 70 when wireless module 70 establishes a connection to the network, along with randomly generated number. The randomly generated number may be used with the unique cryptographic key to generate a signature. Wireless module 70 may provide the randomly generated number to authentication unit 75, which may generate the signature. The signature may be sent by wireless module 70 to the network. If the network-generated signature matches the signature generated by authentication unit 75, then the network authenticates portable computer system 10 as being a valid user.

In a similar manner, wireless module 70 may establish an authenticated wireless session with a computer network via the wireless network using another set of cryptographic keys. For example, using a similar authentication process, the computer network may challenge wireless module 70 and provide a different randomly generated number. Wireless module 70 may provide the new randomly generated number to authentication unit 75, which may generate another signature. This signature may be sent by wireless module 70 to the computer network. If the network-generated signature matches the new signature generated by authentication unit 75, then the computer network may authenticate portable computer system 10 as being a valid user.

In one embodiment, wireless module 70 may be configured to autonomously (i.e., without processor 30 intervention) receive an incoming message or datagram from a remote user and to authenticate the remote user using keys and/or signatures previously stored within authentication unit 75 or a secure memory area (not shown) of wireless module 70. More particularly, the remote user may be authenticated and granted administrative level privileges. Once authenticated, the administrative level user may perform various tasks. For example, if portable computer system 10 is lost or believed to be stolen or otherwise compromised in some way, the administrative level user may send commands to wireless module 70. For example, the administrative level user may query wireless module 70 to determine an operational status of the portable computer system 10 such as the current location, which processes are currently executing, does the memory/storage disk need to be wiped, among others.

Accordingly, in one embodiment the commands may wake up processor 30 if processor 30 is in a low power state such as stand by. In addition, the commands may interrupt processor 30 unconditionally, thereby halting any current processes. Alternatively, the commands may cause all currently executing processes to have a lower priority than any administrative processes that the commands may cause to be initiated, so that the administrative processes may be less likely to be detected. Further, the commands may cause processor 30 to initiate a memory/disk wiping or erasing procedure, and to notify the administrative level user when the wiping procedure is complete. The commands may additionally cause processor 30 and/or portable computer system 10 to be disabled from further operation.

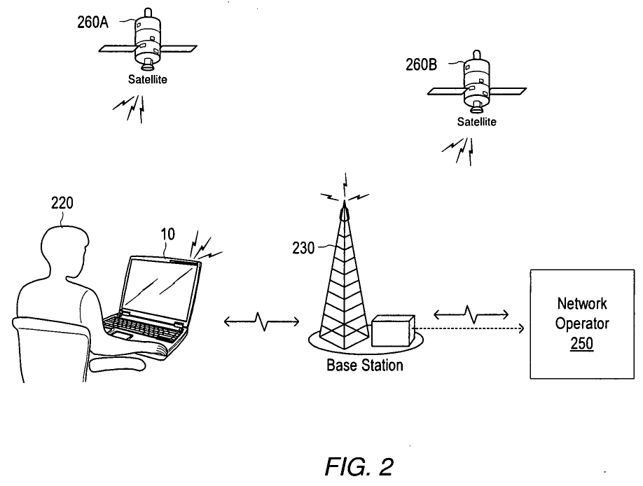

Referring to FIG. 2, a diagram depicting an embodiment of the portable computer system shown in FIG. 1 being used in wireless wide area network is shown. A user 220 is operating portable computer system 10. As shown, portable computer system 10 is a laptop or notebook computer, however it is noted that portable computer system 10 may embody many form factors including a mobile telephone, PDA, or the like. As described above, portable computer system 10 may connect to one or more base stations 230 of a wireless network via the air interface. The base station 230 may provide a connection to network operators and/or network providers via either a wireless connection or a wire line connection as desired. The base station 230 may also provide cell or tower and base station information to portable computer system 10, which may be used to determine a relative location within a given wireless region, for example. In addition, as shown satellite 260A and 260B may provide geographic location information such as global positioning system information as described above.

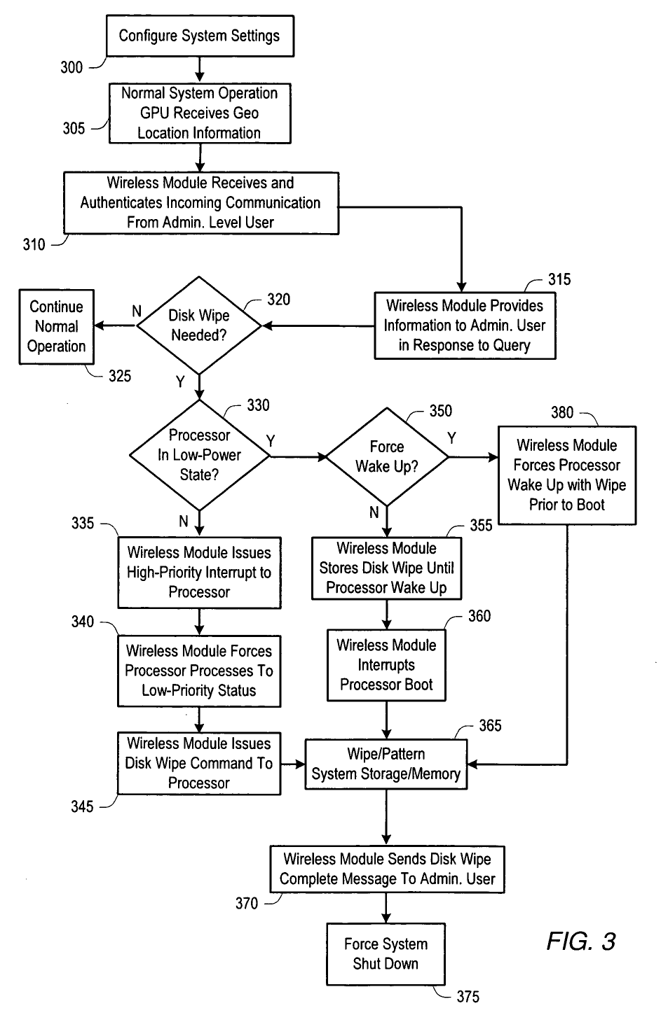

FIG. 3 is a flow diagram describing further operational aspects of the embodiment of the portable computer system shown in FIG. 1. More particularly, as described above, laptop and notebook computers may be used in a changing geographic environment. In addition, they may be misplaced and or stolen. In many cases, valuable and often times sensitive information may be stored on the hard drive or other system storage. Referring collectively to FIG. 1 through FIG. 3, a user may configure system settings. Specifically, in one embodiment, a user having administrative-level privileges may configure the system settings (block 300). For example, passwords and other authentication information may be entered and stored, low-power state operation may be selected, remote access (e.g., IP address) information may be entered, and so on. In addition, system operation including automated tasks, and tasks and functions available to remote users of all types may be configured.

Once the system settings have been configured, portable computer system 10 may be operated normally, as desired (block 305). In one embodiment, during normal operation GPU 95 may receive geographic location information in the form of GPS information via satellite and terrestrial stations, and/or in the form of other geographic location information such as wireless network tower identification information or other local geographic information. As described above, portable computer system 10 may have multiple modes of operation during which processor 30 may be operating normally, or in a low power state such as standby or sleep, for example. In addition, wireless module 70 and GPU 95 may also be awake and operating normally, independent of processor 30. Further, both processor 30 and wireless module 70 may be in low power states. It is also contemplated that in one embodiment, with the exception of a small receiving portion of wireless module 70, the entirety of portable computer system 10 may be powered off.

Accordingly, wireless module 70 may receive an incoming communication in the form of a datagram, for example. The source of the datagram may be identified as possibly being sent by an admin-level user. Wireless module 70 may initiate an authentication request to authentication unit 75 by providing to authentication information included in the datagram. Authentication unit 75 may authenticate the identity of user (block 310). For example, the datagram may include one or more passwords or signatures for use by authentication unit 75. In addition to the authentication information, one or more commands associated with queries may also be included in the datagram. As such, once the user is authenticated and has been verified to have administrative privileges, wireless module 70 may initiate executing the commands. For example, the user may request information such as a current geographic location of portable computer system 10. In addition, other information such as operational state of processor 30 and other peripherals, current processes being executed on processor 30, and the like may be requested in the query. Thus, wireless module 70 may provide the requested information to the user in response to the query (block 315).

In response, the administrative user may determine that portable computer system 10 is not lost or stolen and that the information contained therein may be safe. As such, a disk wipe may not be necessary (block 320). This may be the case, for example, if portable computer system 10 were determined to be somewhere within the owner's facility. Thus, normal operation of portable computer system 10 may be allowed (block 325). However, on the other hand, the administrative user may determine that portable computer system 10 is lost or stolen and/or that the information contained therein may be in a compromising situation depending on a number of factors. As such, the administrative user may determine that a disk wipe may be necessary (block 320). The administrative user may issue various commands to cause the disk wipe operation to commence.

If processor 30 is not in a low power state (block 330), in one embodiment, wireless module 70 may issue a high-priority interrupt to processor 30, thereby halting any currently executing process(es) (block 335). In addition, wireless module 70 may cause all other processes executing on processor 30 to be reprioritized to have a lower priority than the interrupting process (block 340). Further, wireless module 70 may issue a disk wipe command sequence to processor 30 (block 345). For example, the disk wipe command sequence may cause all file structure trees to be eliminated and storage 80 (e.g., hard disk storage, other mass storage devices) and in some embodiments, system memory to be patterned with a data pattern that may render the data stored therein to be useless (block 365). Once the disk wipe sequence completes, wireless module 70 may send a completion message to the administrative user (block 370). In one embodiment, wireless module 70 may cause a system shutdown (block 375).

Referring back to block 330, if processor 30 is in a low power state, the administrative user may opt not to force a wake up of processor 30 (block 350). Instead, wireless module 70 may store the disk wipe command until processor 30 is brought out of the low power state (block 355). For example, the wipe disk command may be stored within a register set or other secure storage within wireless module 70. As processor 30 begins the boot/restore sequence, in one embodiment, wireless module 70 may interrupt the boot/restore sequence with a high priority interrupt prior to the memory image being reloaded. In another embodiment, BIOS may query wireless module 70 during reboots and/or suspend-to-RAM reloads for the presence of disk wipe command, and if detected, prior to the memory image being loaded/reloaded, the disk wipe sequence may be performed as described above in conjunction with block 365.

Referring back to block 350, the administrative user may opt to force a wake up of processor 30. As such, wireless module 70 initiates a wake up with a disk wipe prior to reboot/reload (block 380). For example, similar to above, BIOS may detect the pending disk wipe operation. As such, BIOS may allow wireless module to issue the disk wipe commands for the disk wipe sequence to occur. In another embodiment, wireless module 70 may interrupt the boot sequence executing out of BIOS, prior to the system image being loaded/reloaded as described above in block 360. Disk wipe operation may proceed as described in block 365.

In one specific implementation, the entire portable computer system 10 may be powered off. In such implementations, wireless module 70 may initialize more quickly than processor 30 and the other portions of the computing subsystem. As such, wireless module 70 may be configured to autonomously initiate a connection to a specific server such as a security enterprise server, for example, of a particular computer network. The wireless module 70 may query the server to determine if it is safe/advisable to boot up. If the server answers with a yes, wireless module 70 may not interfere with the boot sequence. However, if the answer is no, the server may respond with the disk wipe command. Accordingly, wireless module 70 may interrupt the boot sequence as described above beginning in either blocks 355 or in block 380, for example, as desired.

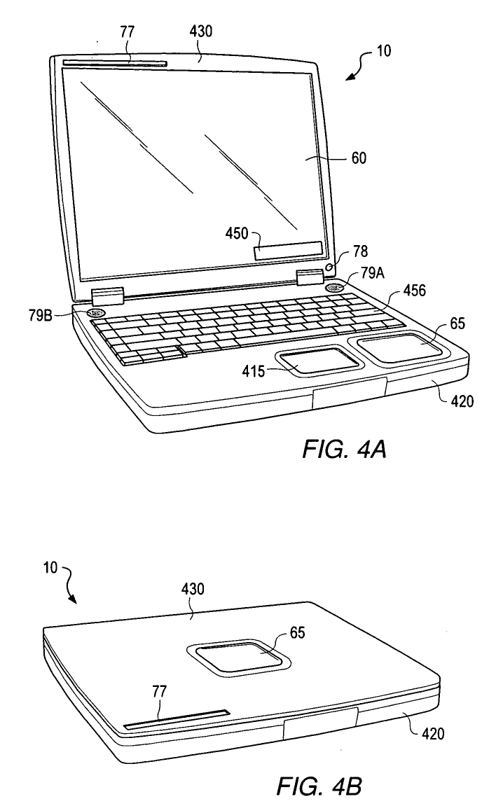

FIG. 4A and FIG. 4B are perspective view drawings of exemplary embodiments of the portable computer system including wireless communication functionality shown in FIG. 1. FIG. 4A depicts the portable computer system 10 as a laptop computer (i.e., a notebook computer) that includes a housing 420 with a hingably attached cover 430 that is in an open position. FIG. 4B depicts another embodiment of the portable computer system 10 with cover 430 in a closed position.

Referring to FIG. 4A, the cover 430 includes a display 60 such as an LCD, microelectro-mechanical (MEMS), or electronic ink (Eink), for example, that forms a part of the internal surface of the cover. In addition, in the illustrated embodiment, portable computer system 10 includes an antenna 77 that is mounted to cover 430. It is noted that the mounting location, type, and numbers of antenna 77 are implementation details. Accordingly, although antenna 77 is shown mounted to the inside of cover 430, in other embodiments, antenna 77 may be mounted to cover 430 or housing 420, or even internal to housing 420 as desired. In addition, antenna 77 may go entirely or partially around display 60.

Portable computer system 10 also includes a microphone 78, speakers 79A and 79B, and a keyboard 456, and a touch activated mouse control 415 that are mounted on a top surface of the housing 420. In addition, portable computer system 10 includes an additional display unit (e.g., LR display 65) mounted to the top surface of housing 420. As described above, in one embodiment, display 65 may beta low-resolution display. In various other embodiments, LR display 65 may also be an input device (e.g., touch-activated screen) to facilitate use of a pointing device such as a stylus, for example. As such, LR display 65 may include analog-to-digital conversion circuits to input data from the screen. It is noted that the location and type of LR display 65 are also implementation details. As such, LR display 65 may be located in any desired location, another example of which is shown in FIG. 4B.

Referring to FIG. 4B, the embodiment of portable computer system 10 shown in FIG. 4B is similar to the embodiment shown in FIG. 4A. However, the embodiment of portable computer system 10 shown in FIG. 4B does not include LR display 65 mounted on the top surface of housing 420. Instead, as illustrated in FIG. 4B, LR display 65 is mounted on the external surface of cover 430 such that LR display 65 is visible and useable when cover 430 is in the closed position. In addition, as noted above, in the illustrated embodiment, antenna 77 is mounted on the external surface of cover 430, but may be mounted internal to housing 420, or any other location, as desired.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A portable computer system comprising:
a processor;
a wireless module coupled to the processor and configured to communicate with a wireless network via a wireless connection; and
a global positioning unit coupled to the wireless module and configured to receive geographic location information and to determine a current geographic location of the portable computer system based upon the received geographic location information.

2. The portable computer system as recited in claim 1, wherein the current geographic location information comprises longitude and latitude information.

3. The portable computer system as recited in claim 1, wherein the current geographic location information comprises elevation.

4. The portable computer system as recited in claim 1, wherein geographic location information comprises a time of day reference clock.

5. The portable computer system as recited in claim 4, wherein the processor is configured to execute application software that uses the geographic location information to update a system clock.

6. The portable computer system as recited in claim 1, wherein geographic location information comprises wireless communication network base station tower location information.

7. The portable computer system as recited in claim 1, wherein geographic location information comprises location beacon information.

8. The portable computer system as recited in claim 1, wherein the processor is configured to execute system software configured to reconfigure system configuration settings dependent upon changes in the current geographic location information.

9. The portable computer system as recited in claim 8, wherein the system configuration settings include wireless network provider information.

10. The portable computer system as recited in claim 8, wherein the system configuration settings include authentication information.

11. The portable computer system as recited in claim 1, further comprising an authentication unit coupled to the wireless module and configured to generate and provide authentication information to the wireless module.

12. The portable computer system as recited in claim 11, wherein the wireless module is further configured to provide the authentication information to a computer network in response to a challenge from the computer network during initiation of a connection to the computer network without intervention by the processor.

13. The portable computer system as recited in claim 12, wherein the wireless module is configured to receive and authenticate an incoming communication from an administrative level user without intervention by the processor.

14. The portable computer system as recited in claim 13, further comprising a storage device coupled to the processor and configured to store system and user information, wherein the wireless module is configured to cause the information within the storage to be unreadable in response to receiving one or more commands received from the administrative level user.

15. The portable computer system as recited in claim 14, wherein the wireless module is configured to interrupt processes running on the processor and to cause the information within the storage to be unreadable in response to receiving the one or more commands.

16. The portable computer system as recited in claim 11, wherein the wireless module is configured to wake up from a low-power state to receive and authenticate an incoming communication from an administrative level user without intervention by the processor.

17. The portable computer system as recited in claim 12, wherein in response to receiving the one or more commands, the wireless module is configured to interrupt the processor during processor boot-up and to cause system and user information within a storage device coupled to the processor to be unreadable prior to allowing a system memory image to be retrieved from the storage.

18. A method comprising:
a wireless module of a computer system communicating with a wireless network via a wireless connection;
the wireless module determining characteristic information associated with the wireless connection;
receiving geographic location information and determining a current geographic location of the portable computer system based upon the received geographic location information.

19. The method as recited in claim 18, further comprising executing system software for reconfiguring system configuration settings dependent upon changes in the current geographic location information.

20. The method as recited in claim 18, further comprising receiving and authenticating an incoming communication from an administrative level user without intervention by a system processor.

21. The method as recited in claim 20, further comprising causing system and user information stored within a system storage to be unreadable in response to receiving one or more commands from the administrative level user.

22. The method as recited in claim 20, further comprising interrupting processes running on a system processor and causing system and user information stored within a system storage to be unreadable in response to receiving the one or more commands.
